(19) United States
(12) Patent Application Publication
(10) Pub. No.: US 2014/0263915 A1
(43) Pub. Date: Sep. 18, 2014

(54) Rapid Deploy Manually Operated Extendible Strut

(71) Applicant: Robert Henry Bernacki, Bloomington, IN (US)

(72) Inventor: Robert Henry Bernacki, Bloomington, IN (US)

(21) Appl. No.: 13/794,890

(22) Filed: Mar. 12, 2013

(51) Int. Cl. F16M 13/02

(52) U.S. Cl. CPC F16M 13/02
USPC 248/354.1

(57) ABSTRACT

A rapid deploy, manually operated, extendible strut device that combines an axially rotated friction mechanism to lock a pair of telescoping tubes in a deployed position, with a linearly operated magnetic mechanism to retain the tubes in a retracted position.

### RELATED APPLICATION DATA

Not Applicable

### FEDERALLY SPONSORED RESEARCH

Not Applicable

### REFERENCE APPENDIX

Not Applicable

### BACKGROUND OF THE INVENTION

The field of the present Invention is related to manually operated linear struts utilized for stabilization of instruments, instrumentation, apparatus, cargo, and the like. Those practiced in the field of manually operated stabilizers, tripods, stands, and the like are familiar with several means for securing linear struts, linear stabilizers, legs and the like, means including thumb screws, bullet catches, lever-actuated friction clamps and locks, and twist or rotationally actuated friction locks. These latter devices have been comprised of various means including screw-expanded friction locks, cam and ring friction locks, and other forms of friction locks. These have, in general, failed to meet the requirements of minimizing dimensions of a strut in a retracted position, minimizing the force required to extend the strut and also minimizing the time required to deploy and retract the strut.

### BRIEF SUMMARY OF THE INVENTION

In the present invention, an improved manually operated strut device is revealed that provides for a minimizing of the dimensions of a strut in a shortened or retracted position, minimizing force required for the locking and unlocking the members of the strut at the retracted position, and minimizing the duration of time required to perform that operation. Improvements are obtained by a new and novel approach that combines a twist-lock friction mechanism employed to lock the strut in a deployed or extended position, with a magnetic catch mechanism employed to retain the strut in a shortened or retracted position. A key feature of the present invention is the elimination of a requirement of a twist-lock only approach, wherein, an additional length of tubing be exposed to permit grasping and twisting to lock or unlock the strut in the retracted position.

The contemplated embodiment of the present invention is comprised of one or more pairs of telescoping tubes, paired as an inner and an outer, wherein the inner is fitted with a rapidly expanding cam ring and crank-cam twist-lock mechanism. A key feature of the contemplated invention is the capability of this cam design for providing excellent linear force capacity while requiring only a only a sixty degree rotation when locking the strut members together. Additionally, the outer tube is fitted with an internal magnetic catch mechanism, incorporating a powerful, rare-earth magnet in a floating configuration, whereby the inner tube is retained within the outer tube in the retracted position. A key feature of the present invention, is that the magnetic catch mechanism eliminates the requirement that an additional length of tubing be exposed to permit sufficient surface for grasping and twisting in the retracted position as is required for a twist-lock mechanism. The strut is further optionally fitted with one or two means for engagement comprised of a flexible ball-joint and a contact plate or other contactor, coupler, or means for grasping, providing alignment and distribution of force between opposing surfaces or points, or combinations thereof, or between two objects, or between a static reference and an object being stabilized.

Additional objects, features, and advantages of the present invention will become apparent to those skilled in the art upon consideration of the following illustration of the contemplated embodiment presented in the detailed description, operation, and accompanying drawings.

### BRIEF DESCRIPTION OF THE DRAWINGS

The detailed description of a contemplated device embodiment of the present invention makes reference to the accompanying figures in which FIG. 1 depicts an exploded perspective view showing all parts of the example strut and FIG. 2 depicts a partial cross-section view revealing locking mechanisms for the device.

### DETAILED DESCRIPTION OF THE INVENTION

Referring now more particularly to the figures, a following description of components and their relationships shall serve to illuminate various particulars of an illustrative embodiment of the disclosures and teachings of the present invention. Throughout the following description are several references to specific components which serve to clarify various aspects of the invention. It will be understood that these specific component references are not limitations and that the teachings and disclosures of the present invention may be practiced with alternative components. In other instances, structures and methods well known to those skilled in the art have been omitted in order to avoid unnecessary complexity which would tend to obscure the teachings and disclosures of the present invention.

Referring now to FIG. 1 and FIG. 2 of an example embodiment of a Rapid Deploy Manually Operated Extendible Strut, an assembly, shown in aggregate as FIG. 2, of a pair of concentric telescopically arranged cylindrical tubes, comprising, an outer tube, referred to by a numeral 2, having a diameter of approximately one half to approximately one inch or as required for accommodating a manual grasp and having a receptive end 20 and a catch end 22. Said outer tube further having at said receptive end 20 and partially incorporated within it, an inner tube 1, said inner tube 1 having a section of a locking end 6 within said outer tube 2. Said inner tube may be of a solid filled type in a basic configuration. Said locking end 6 is axially coupled to a frictional twist-lock mechanism 3 comprising a cam shaft 7, coupled to a cam crank 8, that in turn is coupled to a cam head 10 having a head bore 9, wherein, said cam crank 8 center is offset from said cam shaft 7 center by approximately 10% of said cam shaft 7 diameter and is approximately 45% of the diameter of cam shaft 7. Mounted on said cam crank 8 is a cam ring 11 having a figure eight shape cam bore 12 relieved by a cam ring slot 23, said cam bore 12 having a diameter of approximately 125% of said cam crank 8. A preferred type of material for said cam ring 11 is polypropylene or alternatively, polyethylene. Said cam ring 11 should have a diameter of approximately a few thousandths of an inch less than the inner diameter of said outer tube. Said cam shaft 7 and said cam crank 8 may be from a range of materials as used by those skilled in the art. A preferred type of tube employed is of a “thin-wall” variety possessing a thickness of approximately 3% of the diameter of the tube and having a precision telescoping clearance of approximately one half of a percent of the tube diameter. In this embodiment, said outer tube 2 is of a non-magnetic material such as aluminum, copper, brass, resin bonded fiber, and the like.

Said cam head 10 is coupled to a magnetic catch mechanism 4 comprised of a traveling pole 13, a floating magnet 14, a fixed pole 15, a pole mount 16 and a mount bore 25, wherein said traveling pole 13 is fastened in said head bore 9 in said cam head 10 and said pole mount 16 is fastened internally within said outer tube 2 at the catch end 22. Said fixed pole 15 is fastened in said mount bore 25 of said pole mount 16, facing said traveling pole 13, and is magnetically coupled to said floating magnet 14. Additionally, said outer tube 2 is depicted having an air vent hole 21 adjacent to said fixed pole 15. One advantage of utilizing a magnet in a floating configuration is that of avoiding adhesives, threaded fasteners or press fits and the like, thereby affording simplicity and greater durability over the life of the device. Said floating magnet 14 may be fashioned in a variety of shapes, including, but not limited to, cylindrical and cubic.

One possible embodiment of the invention, as depicted here, additionally has an engagement assembly 5 coupled to a distal end 24 of said inner tube 1, said engagement assembly 5 being comprised of a shaft 19 having a ball joint 18 coupled to a plate 17. Said ball joint 18 should have a range of motion of approximately +/−30 degrees.

Those skilled in the art will recognize a variety of means for fastening or coupling the components described above, including, but not limited to, chemical adhesive bonding; thermal bonding, including the addition of solders or rods of metal or plastic material; and mechanical, methods including threaded fasteners, rivets, swaging and staking.

A description of the operation of the invention is now presented in the following review of the general mechanical operation and is merely for illustrative purposes. The description following should in no way be considered either the sole or limiting view of the breadth and range of possible operational characteristics. Considering the operation of a single stage device embodiment, as depicted in FIGS. 1 and 2, and assuming it in a retracted state, a linear force is applied to inner tube 1 along the main axis of the inner tube 1 relative to the outer tube 2, releasing the magnetic catch mechanism 4, disengagement of the magnetically coupled floating magnet 14 being from either the traveling pole 13 or the fixed pole 15, and subsequently moving the inner tube 1 away from the catch end 22, thereby lengthening the strut. Said inner tube 1 may then be linearly positioned in nearly infinite increments along the length of the outer tube 2. At the desired position, the twist-lock mechanism 3 is engaged by the rotation of the inner tube 1 in either a clockwise or counter-clockwise direction through an approximately sixty degree rotation, wherein the cam shaft 7 rotates the cam crank 8, said rotation subsequently converted by the combined motion of the cam crank 8 and cam ring 11 assembly into a radial force applied to the outer tube 2 by the cam ring 11, thereby creating a frictional lock between the two tubes. The tubes specified herein are of the precision type, resulting in an assembly that requires an air vent hole 21 in the outer tube 2 adjacent to the fixed pole 15 to permit the escape of air due to the displacement of air in the outer tube when the inner tube is moved in relation to it and thus avoiding a build-up of air pressure in the outer tube 2 that would resist such movement.

In the present invention, an improved strut device may be employed in a variety of circumstances, therefore, the following review of two scenarios of operation are merely for illustrative purposes and should in no way be considered either the only or limiting views of the breadth and range of possible operational characteristics.

In a first case scenario, the means for engagement would couple one end of the strut to an electronic instrument device or the like that is being stabilized, while the other end would be attached to a foot consisting of the above described contactor plate. The strut would normally be in the retracted position when not in use until it became necessary to deploy the strut, whereupon, an operator would pull the foot, disengaging the magnetic catch and drawing the inner tube linearly outward, extending the strut to a desired length to contact a supporting surface, positioned in nearly infinite increments, subsequently grasping the inner tube, and rotating or twisting about a sixth of a turn relative to the outer tube, thereby engaging the twist-lock mechanism causing it to frictionally lock the inner tube relative to the outer tube. The contactor plate ball joint typically accommodates an angle of the strut, relative to and generally perpendicular, to the contacted surface of seventy to ninety degrees. When the occasion arrives to retract and stow the strut or leg, the operator grasps the inner tube, rotates it approximately sixty degrees in an opposite direction from that of the locking rotation, disengaging the twist-lock mechanism, and then linearly pushes the inner tube back into the outer tube whereby the magnetic catch pole pieces engage again, retaining the inner tube in the retracted position.

In a second case scenario, a similar sequence of events would transpire, however, the strut would be fitted with means for engagement such as a flexible ball-joint coupled contact plates at both ends permitting the application of a restraining force to opposing surfaces being stabilized such as containers of cargo or other means for storage, wherein the operator would align the strut for optimal application of force required to maintain the position of said means for storage.

The present invention reveals apparatus and methods which provide for the resistance of a linear force of tension and/or compression through application of a manually operated linear strut, either singly or in sets, such as those utilized for stabilization of instruments, cargo, apparatus and the like, wherein, such applications it is desirable, and even necessary, to minimize dimensions of a strut in a retracted position, minimize the force required to extend the strut and also minimize the time required to deploy the strut. The application of the Invention may consist of one or more telescoping tube pair assemblies cascaded as nested stages, whereby an inner tube becomes an outer tube for a next smaller diameter stage and an outer tube becomes an inner tube inserted in a larger diameter tube to form another stage and so forth.

Those skilled in the art will conceive of many applications that require a device based upon the present invention, however, the present invention is not suitable, nor intended, for applications or situations where human physical safety is involved or dependent upon such devices. Although one possible embodiment has been described to illustrate the teachings and disclosures of the present invention, it is not limited to the specific foregoing illustrative embodiment or applications and that various and several modifications in design, arrangement, and use may be made within the scope and spirit of the invention as expressed in the following

What is claimed is:

1. A manually operated extendable strut comprising:
an assembly of at least two concentric telescopically mated tubes comprising;
an outer tube having a first end and a second end;
an inner tube, having an end section partially incorporated within said outer tube at said first end;
a magnetic catch mechanism comprising;
a first part coupled to said outer tube at said second end;
a second part coupled to said inner tube at said end section;
a lock mechanism;
wherein said lock mechanism, proximal to said outer tube first end and proximal to said inner tube end section, retains the outer tube to the inner tube.

2. The manually operated extendable strut of claim 1, said magnetic catch mechanism further comprising:
a first pole piece coupled to a first part;
a second pole piece coupled to a second part;
a magnet magnetically coupled to at least one of said first pole piece or said second pole piece.

3. The manually operated extendable strut of claim 1, said lock mechanism being of a twist-lock type.

4. The manually operated extendable strut of claim 1, said inner tube being solid filled.

5. A manually operated extendable strut, comprising:
an outer tube having a receptive end and a catch end;
an inner tube being telescopically slidable within said outer tube at said receptive end;
a means for locking said inner tube to said outer tube, coupled to said inner tube and enclosed by said outer tube;
a magnetic catch mechanism having a first part coupled to said outer tube at said catch end;
a second part of said magnetic catch mechanism coupled to said locking means;
wherein sliding said inner tube towards said catch end magnetically engages said first part with said second part of said magnetic catch mechanism.

6. The manually operated extendable strut of claim 5, said magnetic catch mechanism further comprising:
a first pole piece coupled to a first part;
a second pole piece coupled to a second part;
a magnet magnetically coupled to at least one of said first pole piece or said second pole piece.

7. The manually operated extendable strut of claim 5, said means for locking comprising:
a cam shaft;
a cam crank coupled to said cam shaft;
a cam ring mounted on said cam crank;
wherein, a rotation of the inner tube in either a clockwise or counter-clockwise direction through an approximately sixty degree rotation, rotates said cam shaft, in turn rotating said cam crank, said rotation subsequently converted by a combined motion of said cam crank and said cam ring into a radial force applied to said outer tube, thereby creating a frictional lock between said tubes.

8. The manually operated extendable strut of claim 5, said means for locking further comprising:
a cam bore;
wherein, said cam crank is offset from center by approximately 10% of a diameter of said inner tube diameter, said cam crank having a diameter of approximately 45% of said diameter of said inner tube, and a diameter of said cam bore being approximately 125% of said diameter of said cam crank.

9. The manually operated extendable strut of claim 5, said inner tube being solid filled.

10. The manually operated extendable strut of claim 5, said inner tube and said outer tube being approximately one half inch to approximately one inch in diameter.

11. The manually operated extendable strut of claim 5, said inner tube and said outer tube being of a “thin-wall” variety possessing a thickness of approximately 3% of a diameter of said tubing and having a precision telescoping clearance of less than one half of a percent of said diameter of said tubing.

12. The manually operated extendable strut of claim 5, further comprising:
a means for engaging objects comprising;
a shaft coupled to a distal end of said inner tube;
a ball joint coupled to said shaft;
a plate coupled to said ball joint;
wherein, the means for engaging objects accommodates a range of motion of +/−30 degrees.

13. The manually operated extendable strut of claim 5, said inner tube and said outer tube being of a non-magnetic material.

14. The manually operated extendable strut of claim 5, said outer tube further comprising:
A vent hole bored into said outer tube proximal to said magnetic catch mechanism first part.

15. The manually operated extendable strut of claim 5, further comprising:
a means for engaging objects comprising;
a shaft coupled to a distal end of said inner tube;
a ball joint coupled to said shaft;
a plate coupled to said ball joint;
wherein, the means for engaging objects accommodates a range of motion of +/−30 degrees.

16. A manually operated extendable strut, comprising:
a first tube assembly, having a locking end, comprising;
a twist-lock mechanism, coupled to said locking end, comprising;
a cam shaft;
a cam crank coupled to said cam shaft;
a cam ring mounted on said cam crank;
a first magnetic pole coupled to said twist-lock mechanism;
a second tube assembly, having a receptive end and a catch end, comprising;
a magnetic catch, coupled to said catch end, comprising;
a second magnetic pole;
a magnet magnetically coupled to said second magnetic pole;
wherein said first tube assembly is telescopically slidable within said second tube assembly, said locking end enclosed within said second tube assembly at said receptive end, said twist-lock mechanism operable by rotating said first tube assembly relative to said second tube assembly, and, said magnetic catch operable by linearly moving said first tube assembly linearly within said second tube assembly, in a first direction to separate said magnet from said first magnetic pole or said second magnetic pole, or in a second direction to engage said magnet simultaneously with both said first magnetic pole and said second magnetic pole.

17. The manually operated extendable strut of claim 16, said twist-lock mechanism further comprising:
a cam bore;
wherein, said cam crank is offset from center by approximately 10% of a diameter of said inner tube diameter, said cam crank having a diameter of approximately 45% of said diameter of said inner tube, and a diameter of said cam bore being approximately 125% of said diameter of said cam crank.

18. The manually operated extendable strut of claim 16, said first tube assembly being solid filled.

19. The manually operated extendable strut of claim 16, said first tube assembly and second tube assembly being approximately one half inch to approximately one inch in diameter.

20. The manually operated extendable strut of claim 16, said first tube assembly and second tube assembly being of a “thin-wall” variety possessing a thickness of approximately 3% of a diameter of said tubing and having a precision telescoping clearance of less than one half of a percent of said diameter of said tubing.

21. The manually operated extendable strut of claim 16, said first tube assembly and second tube assembly being of a non-magnetic material.

22. The manually operated extendable strut of claim 16, further comprising:
a means for engaging objects comprising;
a shaft coupled to a distal end of said first tube assembly;
a ball joint coupled to said shaft;
a plate coupled to said ball joint;
wherein, the means for engaging objects accommodates a range of motion of +/−30 degrees.
